(19) United States
(12) Patent Application Publication
(10) Pub. No.: US 2025/0079941 A1
(43) Pub. Date: Mar. 6, 2025

(54) MOTOR

(71) Applicant: HYUNDAI MOBIS CO., LTD., Seoul (KR)

(72) Inventor: Tae Wook HA, Yongin-si (KR)

(73) Assignee: HYUNDAI MOBIS CO., LTD., Seoul (KR)

(21) Appl. No.: 18/624,956

(22) Filed: Apr. 2, 2024

(30) Foreign Application Priority Data
Sep. 1, 2023 (KR) 10-2023-0116544

(51) Int. Cl. H02K 9/193; H02K 5/20; H02K 7/116

(52) U.S. Cl. CPC H02K 9/193; H02K 5/203; H02K 7/116

(57) ABSTRACT

The present disclosure relates to a motor including a motor housing, a stator provided in the motor housing, a coil wound around the stator, a rotor rotatably provided inside the stator, a water-cooled cooling part provided in the motor housing and including a water jacket configured to define a coolant flow path through which a coolant circulates, and an oil-cooled cooling part provided in the motor housing and configured to spray cooling oil to the coil, thereby obtaining an advantageous effect of improving cooling performance, stability, and reliability.

### CROSS-REFERENCE TO RELATED APPLICATION

This application claims priority to and the benefit of Korean Patent Application No. 10-2023-0116544 filed in the Korean Intellectual Property Office on Sep. 1, 2023, the entire contents of which are incorporated herein by reference.

### TECHNICAL FIELD

The present disclosure relates to a motor, and more particularly, to a motor capable of improving cooling performance, safety, and reliability.

### BACKGROUND ART

A hybrid vehicle or an electric vehicle, which is called an environmentally friendly vehicle, generates driving power using an electric motor (hereinafter, referred to as a ‘drive motor’) that obtains rotational force from electrical energy.

In general, the drive motor includes a stator coupled to a housing, and a rotor rotatably disposed in the stator with a predetermined air gap from the stator.

The stator includes a core made by stacking electric steel sheets and having a plurality of coil winding portions, and a stator coil wound around the core.

Meanwhile, high-temperature heat is generated in the motor because of eddy currents created in the stator. When the temperature of the motor is raised to a predetermined temperature, the efficiency and lifespan of the motor may deteriorate. Therefore, it is necessary to essentially cool the motor to prevent damage caused by heat and consistently enable stable operability.

However, in the related art, it is difficult to effectively cool both a core portion of the coil, which corresponds to a tooth portion of a core, and an end turn portion of the coil exposed (protruding) to an end of the stator. For this reason, it is difficult to ensure sufficient performance in cooling the motor.

Recently, various studies have been conducted to improve the performance in cooling the motor, but the study results are still insufficient. Accordingly, there is a need to develop a technology to improve the performance in cooling the motor.

### SUMMARY

The present disclosure has been made in an effort to provide a motor for an electric vehicle, which is capable of improving cooling performance, stability, and reliability.

In particular, the present disclosure has been made in an effort to effectively ensure both performance in cooling a core portion of a coil (or a stator) and performance in cooling an end turn portion of the coil.

The present disclosure has also been made in an effort to simplify a structure and reduce costs.

The present disclosure has also been made in an effort to minimize power consumption and improve energy efficiency.

The objects to be achieved by the embodiments are not limited to the above-mentioned objects, but also include objects or effects that may be understood from the solutions or embodiments described below.

In order to achieve the above-mentioned objects, an exemplary embodiment of the present disclosure provides a motor including: a motor housing; a stator provided in the motor housing; a coil wound around the stator; a rotor rotatably provided inside the stator; a water-cooled cooling part provided in the motor housing and including a water jacket configured to define a coolant flow path through which a coolant circulates; and an oil-cooled cooling part provided in the motor housing and configured to spray cooling oil to the coil.

This is to improve the performance in cooling the motor for a vehicle and improve the stability and reliability.

That is, high-temperature heat is generated in the motor because of eddy currents created in the stator. When the temperature of the motor is raised to a predetermined temperature, the efficiency and lifespan of the motor may deteriorate. Therefore, it is necessary to essentially cool the motor to prevent damage caused by heat and consistently enable stable operability.

However, in the related art, it is difficult to effectively cool both a core portion of the coil, which corresponds to a tooth portion of a core, and an end turn portion of the coil exposed (protruding) to an end of the stator. For this reason, it is difficult to ensure sufficient performance in cooling the motor.

In contrast, the embodiment of the present disclosure provides the water-cooled cooling part and the oil-cooled cooling part together. Therefore, it is possible to obtain an advantageous effect of improving the performance in cooling the motor and improving the stability and reliability.

Among other things, in the embodiment of the present disclosure, the water-cooled cooling part cools the core portion of the coil (or the stator), and the oil-cooled cooling part cools the end turn portion of the coil. Therefore, it is possible to obtain an advantageous effect of minimizing a temperature deviation (cooling performance deviation) between the core portion of the coil and the end turn portion and more effectively eliminating heat generated by the stator and the coil.

According to the exemplary embodiment of the present disclosure, the water jacket may be provided to surround a periphery of the stator while corresponding to the stator, and the oil-cooled cooling part may spray the cooling oil to an end turn portion of the coil exposed to an end of the stator.

The oil-cooled cooling part may have various structures capable of spraying the cooling oil directly to the coil.

According to the exemplary embodiment of the present disclosure, the oil-cooled cooling part may include: a cooling oil flow path provided in the motor housing and configured to guide the cooling oil, which is stored at a lower side of the motor housing, to a position above the coil based on a gravitational direction; a spray hole provided in the motor housing and configured to communicate with the cooling oil flow path and spray the cooling oil to the coil; and an oil pump provided in the cooling oil flow path and configured to pump the cooling oil.

According to the exemplary embodiment of the present disclosure, the spray hole may include: a first spray hole provided in the motor housing while corresponding to a first end turn portion of the coil exposed to one end of the stator; and a second spray hole provided in the motor housing while corresponding to a second end turn portion of the coil exposed to the other end of the stator.

According to the exemplary embodiment of the present disclosure, the oil pump may be configured to pump the cooling oil on the basis of a rotation of the rotor.

As described above, in the embodiment of the present disclosure, the amount of the cooling oil to be pumped by the oil pump varies depending on the rotational speed of the rotor, such that the amount of the cooling oil to be sprayed to the coil may increase as the amount of heat generation of the coil is increased by the increase in rotational speed of the rotor. Therefore, it is possible to obtain an advantageous effect of stably ensuring the performance in cooling the coil.

Moreover, in the embodiment of the present disclosure, the amount of the cooling oil to be sprayed to the coil is adjusted depending on the rotational speed of the rotor. Therefore, it is not necessary to additionally provide a temperature sensor for detecting a temperature of the cooling oil and a controller for controlling the operation of the oil pump in response to a signal detected by the temperature sensor. Therefore, it is possible to obtain an advantageous effect of simplifying the structure and operational structure and reducing costs.

According to the exemplary embodiment of the present disclosure, the motor may include a power transmission part configured to transmit a rotational force of the rotor to the oil pump as driving power. The oil pump may pump the cooling oil on the basis of the rotation of the rotor by means of the power transmission part.

As described above, in the embodiment of the present disclosure, the oil pump may be operated by the rotational force of the rotor by means of the power transmission part, and a separate motor or power device for operating the oil pump may be excluded. Therefore, it is possible to obtain an advantageous effect of simplifying the structure and improving the spatial utilization and degree of design freedom.

In addition, in the embodiment of the present disclosure, the oil pump may be operated by the rotational force of the rotor, such that the oil pump may be operated without additional consumption of electric power for operating the oil pump. Therefore, it is possible to obtain an advantageous effect of improving energy efficiency.

According to the exemplary embodiment of the present disclosure, the power transmission part may include: a first gear connected to a shaft of the rotor; and a second gear connected to the oil pump and configured to engage with the first gear.

According to the exemplary embodiment of the present disclosure, the second gear may be configured to simultaneously serve as a power transmission device, which transmits the rotational force of the first gear to the oil pump, and a speed reduction device that reduces the rotational speed of the first gear.

For example, the first gear and the second gear may be defined to be different in number of teeth. The second gear may be configured to rotate at a lower rotational speed than the first gear.

According to the exemplary embodiment of the present disclosure, the motor may include a heat exchange part configured to allow the coolant in the water-cooled cooling part to exchange heat with the cooling oil in the oil-cooled cooling part.

The heat exchange part may have various structures capable of allowing the coolant and the cooling oil to exchange heat with each other.

According to the exemplary embodiment of the present disclosure, the heat exchange part may include a heat exchange flow path defined between the stator and the motor housing, and the cooling oil, which is stored at a lower side of the motor housing, may be cooled by heat exchange with the coolant while moving along the heat exchange flow path.

As described above, in the embodiment of the present disclosure, the cooling oil is cooled by the heat exchange with the coolant while moving along the heat exchange flow path, such that the cooling performance implemented by the cooling oil may be stably ensured. Further, because a separate cooling device for cooling the cooling oil is not required, it is possible to obtain an advantageous effect of simplifying the structure and operational structure and reducing costs.

### BRIEF DESCRIPTION OF THE DRAWINGS

FIG. 1 is a view for explaining a motor according to an embodiment of the present disclosure.

FIG. 2 is a view for explaining a movement route for a second cooling medium of the motor according to the embodiment of the present disclosure.

### DETAILED DESCRIPTION

Hereinafter, exemplary embodiments of the present disclosure will be described in detail with reference to the accompanying drawings.

However, the technical spirit of the present disclosure is not limited to some embodiments described herein but may be implemented in various different forms. One or more of the constituent elements in the embodiments may be selectively combined and substituted for use within the scope of the technical spirit of the present disclosure.

In addition, unless otherwise specifically and explicitly defined and stated, the terms (including technical and scientific terms) used in the embodiments of the present disclosure may be construed as the meaning which may be commonly understood by the person with ordinary skill in the art to which the present disclosure pertains. The meanings of the commonly used terms such as the terms defined in dictionaries may be interpreted in consideration of the contextual meanings of the related technology.

In addition, the terms used in the embodiments of the present disclosure are for explaining the embodiments, not for limiting the present disclosure.

In the present specification, unless particularly stated otherwise, a singular form may also include a plural form. The expression “at least one (or one or more) of A, B, and C” may include one or more of all combinations that can be made by combining A, B, and C.

In addition, the terms such as first, second, A, B, (a), and (b) may be used to describe constituent elements of the embodiments of the present disclosure.

These terms are used only for the purpose of discriminating one constituent element from another constituent element, and the nature, the sequences, or the orders of the constituent elements are not limited by the terms.

Further, when one constituent element is described as being ‘connected’, ‘coupled’, or ‘attached’ to another constituent element, one constituent element may be connected, coupled, or attached directly to another constituent element or connected, coupled, or attached to another constituent element through still another constituent element interposed therebetween.

In addition, the expression “one constituent element is provided or disposed above (on) or below (under) another constituent element” includes not only a case in which the two constituent elements are in direct contact with each other, but also a case in which one or more other constituent elements are provided or disposed between the two constituent elements. The expression “above (on) or below (under)” may mean a downward direction as well as an upward direction based on one constituent element.

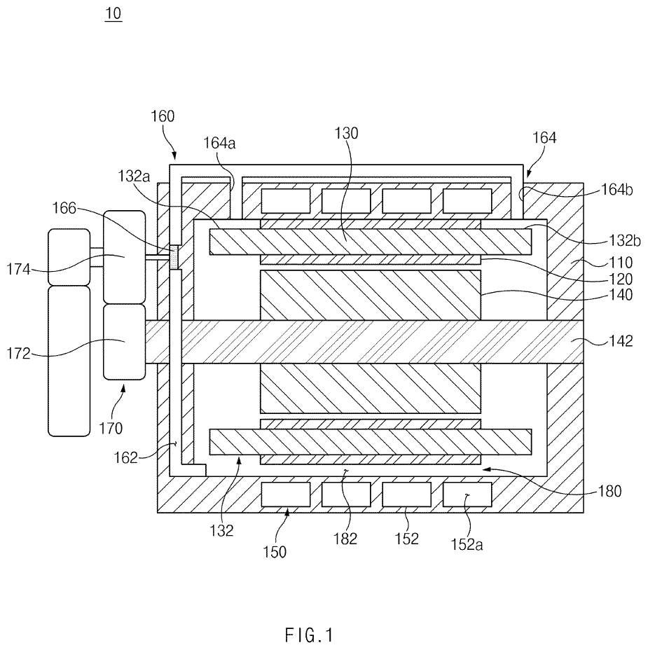

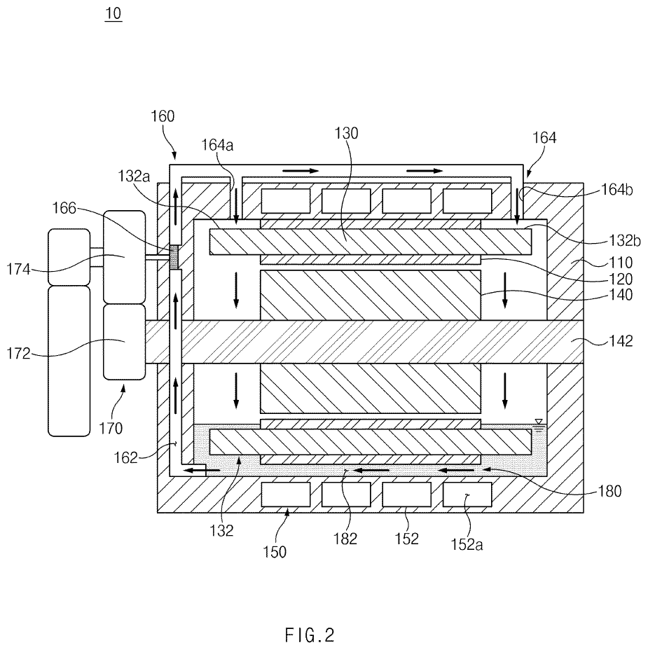

With reference to FIGS. 1 to 2, a motor 10 according to an embodiment of the present disclosure includes a motor housing 110, a stator 120 provided in the motor housing 110, a coil 130 wound around the stator 120, a rotor 140 rotatably provided inside the stator 120, a water-cooled cooling part 150 provided in the motor housing 110 and including a water jacket 152 configured to define a coolant flow path 152a through which a coolant circulates, and an oil-cooled cooling part 160 provided in the motor housing 110 and configured to spray cooling oil CO to the coil 130.

For reference, the motor 10 according to the embodiment of the present disclosure may be applied to various objects in accordance with required conditions and design specifications. The present disclosure is not restricted or limited by the type and properties of the object to which the motor 10 is applied.

For example, the motor 10 according to the embodiment of the present disclosure may be used as a drive motor for a hybrid vehicle or an electric vehicle.

The motor housing 110 may have a predetermined accommodation space therein, and the stator 120 may be accommodated in the motor housing 110.

The motor housing 110 may have a shape and structure capable of accommodating the stator 120 therein. The present disclosure is not restricted or limited by the shape and structure of the motor housing 110.

The stator 120 may be seated in the motor housing 110. The coil 130 is wound around the stator 120 to induce an electrical interaction between the stator 120 and the rotor 140.

More specifically, the stator 120 may include a stator core (not illustrated) provided to have a hollow cylindrical shape.

The stator core may have various structures in which a plurality of teeth (not illustrated) is provided along an inner peripheral surface thereof and spaced apart from one another, and slots (not illustrated) are defined between the teeth. The present disclosure is not restricted or limited by the structure and size (standard) of the stator core.

For example, the stator core may be made by stacking a plurality of electric steel sheets in an axial direction of the stator 120. According to another embodiment of the present disclosure, the stator core may be made by using a plurality of split cores that collectively defines a ring shape.

The coil 130 may be made of a typical metallic material (e.g., copper) capable of defining a magnetic path. The present disclosure is not restricted or limited by the material and shape of the coil 130.

For example, an annular coil 130 having a circular cross-section may be used as the coil 130. According to another embodiment of the present disclosure, a flat coil (also referred to as an angular copper wire or a hairpin) having an angular cross-section (e.g., a quadrangular cross-section) may be used as the coil.

In the state in which the coil 130 is disposed (wound) in the stator 120, ends (end turn portions) of the coil 130, which are exposed to the outside of the stator 120 (left and right ends of the stator based on an axial direction based on FIG. 1), may be twisted in a predetermined posture and then welded. For example, end turn portions 132 of the coil 130, which are exposed to the outside of the stator 120, may be disposed to define an approximately ring shape.

The rotor 140 is rotated by an electrical interaction between the rotor 140 and the stator 120 and configured to provide driving power to the object.

The rotor 140 may have various structures capable of being rotated by the electrical interaction between the rotor 140 and the stator 120. The present disclosure is not restricted or limited by the type and structure of the rotor 140.

For example, the rotor 140 may include a rotor core (not illustrated) and magnets (not illustrated). The rotor core may have a structure made by stacking a plurality of circular plates each provided in the form of a thin steel sheet or be provided in the form of a bin.

A shaft hole (not illustrated) may be provided at a center of the rotor 140, and a shaft 142 may be coupled to the shaft hole.

Protrusions (not illustrated) may protrude from an outer peripheral surface of the rotor core and guide the magnets. The magnets may be attached to the outer peripheral surface of the rotor core and spaced apart from one another at predetermined intervals in a peripheral direction of the rotor core.

In addition, the rotor 140 may include a can member (not illustrated) configured to surround the magnets and inhibit the separation of the magnets.

The water-cooled cooling part 150 is configured to cool the stator 120 (or the core portion of the coil) by means of the coolant.

More specifically, the water-cooled cooling part 150 may include the water jacket 152 provided in the motor housing 110 and configured to define the coolant flow path 152a through which the coolant circulates. The stator 120, which is in contact with an inner surface of the motor housing 110, may be cooled by heat exchange (thermal conduction) with the coolant that circulates along the water jacket 152.

According to the exemplary embodiment of the present disclosure, the water jacket 152 may be configured to surround a periphery of the stator 120 while corresponding to the stator 120. For example, the water jacket 152 may be provided to have a length (a length of the water jacket in the axial direction of the stator) corresponding to an axial length of the stator 120.

The water jacket 152 may have various structures capable of defining the coolant flow path 152a. The present disclosure is not restricted or limited by the structure and shape of the water jacket 152.

For example, the water jacket 152 may have an approximately spiral shape and be provided in the motor housing 110. For example, the motor housing 110 may be injection-molded to surround a periphery of the water jacket 152.

According to another embodiment of the present disclosure, the water jacket may be provided in a straight shape or other shapes in the axial direction of the stator. Alternatively, the water jacket may be attached to the inner or outer surface of the motor housing.

A typical cooling medium (e.g., water) may be used as the coolant that circulates along the coolant flow path 152a. The present disclosure is not restricted or limited by the type and properties of the coolant.

The oil-cooled cooling part 160 is provided in the motor housing 110 and configured to spray the cooling oil CO directly to the coil 130.

For reference, in the embodiment of the present disclosure, a process of spraying the cooling oil CO to the coil 130 may be defined as including both a process of dripping the cooling oil CO to the coil 130 and a process of spraying the cooling oil CO to the coil 130.

According to the exemplary embodiment of the present disclosure, the oil-cooled cooling part 160 may spray the cooling oil CO to the end turn portions 132 of the coil 130 exposed to the ends of the stator 120 (e.g., the left and right ends of the stator 120 based on the axial direction based on FIG. 1).

The oil-cooled cooling part 160 may have various structures capable of spraying the cooling oil CO directly to the coil 130. The present disclosure is not restricted or limited by the structure of the oil-cooled cooling part 160.

According to the exemplary embodiment of the present disclosure, the oil-cooled cooling part 160 may include a cooling oil flow path 162 provided in the motor housing 110 and configured to guide the cooling oil CO, which is stored at a lower side of the motor housing 110, to a position above the coil 130 based on the gravitational direction, a spray hole 164 provided in the motor housing 110 and configured to communicate with the cooling oil flow path 162 and spray the cooling oil CO to the coil 130, and an oil pump 166 provided in the cooling oil flow path 162 and configured to pump the cooling oil CO.

The cooling oil flow path 162 may have various structures capable of guiding the cooling oil CO, which is stored at the lower side of the motor housing 110, to the position above the coil 130 based on the gravitational direction. The present disclosure is not restricted or limited by the structure and shape of the cooling oil flow path 162.

For example, the cooling oil flow path 162 may be defined along an approximately “U”-shaped tube provided in the motor housing 110. For example, a part of the tube (e.g., a vertical tube portion in a vertical direction), which defines the cooling oil flow path 162, may be disposed in the motor housing 110, and the remaining part of the tube (e.g., a horizontal tube portion in a horizontal direction) may be disposed outside the motor housing 110.

In particular, an inlet end of a second cooling medium flow path may be disposed at a height lower than a water level of a second cooling medium stored at the lower side of the motor housing 110.

The spray hole 164 may have various structures capable of spraying the cooling oil CO to the coil 130. The present disclosure is not restricted or limited by the structure and shape of the spray hole 164.

For example, the spray hole 164 may communicate with the cooling oil flow path 162 and be provided through an upper surface (based on FIG. 1) of the motor housing 110 that faces an uppermost end of the coil 130.

According to the exemplary embodiment of the present disclosure, the spray hole 164 may include a first spray hole 164a provided in the motor housing 110 while corresponding to a first end turn portion 132a of the coil 130 exposed to one end of the stator 120 (the left end of the stator based on FIG. 1), and a second spray hole 164b provided in the motor housing 110 while corresponding to a second end turn portion 132b of the coil 130 exposed to the other end of the stator 120 (the right end of the stator based on FIG. 1).

In the embodiment of the present disclosure illustrated and described above, the example has been described in which the spray hole 164 includes both the first spray hole 164a and the second spray hole 164b. However, according to another embodiment of the present disclosure, the spray hole may include only any one of the first spray hole and the second spray hole.

In addition, in the embodiment of the present disclosure illustrated and described above, the example has been described in which the spray hole 164 is provided in the upper surface of the motor housing 110. However, according to another embodiment of the present disclosure, the spray hole may be provided in a sidewall of the motor housing.

The oil pump 166 is provided in the cooling oil flow path 162 and configured to forcibly pump the cooling oil CO, which is stored at the lower side of the motor housing 110, to the position above the coil 130 along the cooling oil flow path 162.

A typical pump capable of pumping the cooling oil CO may be used as the oil pump 166. The present disclosure is not restricted or limited by the type and structure of the oil pump 166.

The oil pump 166 may be configured to operate (pump the oil) in various ways in accordance with required conditions and design specifications. The present disclosure is not restricted or limited by the method of operating the oil pump 166.

According to the exemplary embodiment of the present disclosure, the oil pump 166 may be configured to pump the cooling oil CO on the basis of a rotation of the rotor 140.

In this case, the configuration in which the oil pump 166 pumps the cooling oil CO on the basis of the rotation of the rotor 140 may be understood as a configuration in which the oil pump 166 operates to pump the cooling oil CO when the rotor 140 rotates, and the operation of the oil pump 166 is stopped (the operation of pumping the cooling oil CO is stopped) when the rotation of the rotor 140 is stopped. The amount of the cooling oil CO to be pumped by the oil pump 166 may vary depending on a rotational speed of the rotor 140.

According to the exemplary embodiment of the present disclosure, the motor 10 may include a power transmission part 170 configured to transmit a rotational force of the rotor 140 to the oil pump 166 as driving power. The oil pump 166 may pump the cooling oil CO on the basis of the rotation of the rotor 140 by means of the power transmission part 170.

The power transmission part 170 may have various structures capable of transmitting the rotational force of the rotor 140 to the oil pump 166. The present disclosure is not restricted or limited by the structure of the power transmission part 170.

According to the exemplary embodiment of the present disclosure, the power transmission part 170 may include a first gear 172 coupled to the shaft 142 of the rotor 140, and a second gear 174 connected to the oil pump 166 and configured to engage with the first gear 172.

Typical spur gears may be used as the first gear 172 and the second gear 174. The present disclosure is not restricted or limited by the types and structures of the first and second gears 172 and 174.

With the above-mentioned structure, when the first gear 172 is rotated by the rotation of the shaft 142 of the rotor 140, the second gear 174 engaging with the first gear 172 rotates, such that the oil pump 166 may pump the cooling oil CO on the basis of the rotation of the rotor 140.

According to the exemplary embodiment of the present disclosure, the second gear 174 may be configured to simultaneously serve as a power transmission device, which transmits the rotational force of the first gear 172 to the oil pump 166, and a speed reduction device that reduces the rotational speed of the first gear 172.

For example, the first gear 172 and the second gear 174 may be defined to be different in number of teeth. The second gear 174 may be configured to rotate at a lower rotational speed than the first gear 172.

More specifically, the second gear 174 may be defined to have a larger number of teeth than the first gear 172, and the second gear 174 may rotate at a rotational speed lower than the rotational speed of the first gear 172.

The second gear 174 may have various structures capable of reducing the rotational speed of the first gear 172 while serving to transmit the rotational force of the first gear 172 to the oil pump 166. The present disclosure is not restricted or limited by the structure and type of the second gear 174.

For example, the second gear 174 may be configured as a gearbox structure made by combining a plurality of gears. Alternatively, the second gear 174 may include a single gear.

In the embodiment of the present disclosure illustrated and described above, the example has been described in which the second gear 174 rotates at the rotational speed lower than the rotational speed of the first gear 172. However, according to another embodiment of the present disclosure, the first and second gears may be configured to rotate at the same speed.

As described above, in the embodiment of the present disclosure, the oil pump 166 may be operated by the rotational force of the rotor 140, and a separate motor or power device for operating the oil pump 166 may be excluded. Therefore, it is possible to obtain an advantageous effect of simplifying the structure and improving the spatial utilization and degree of design freedom.

In addition, in the embodiment of the present disclosure, the oil pump 166 may be operated by the rotational force of the rotor 140, such that the oil pump 166 may be operated without additional consumption of electric power for operating the oil pump 166. Therefore, it is possible to obtain an advantageous effect of improving energy efficiency.

In addition, in the embodiment of the present disclosure, the amount of the cooling oil CO to be pumped by the oil pump 166 varies depending on the rotational speed of the rotor 140, such that the amount of the cooling oil CO to be sprayed to the coil 130 may increase as the amount of heat generation of the coil 130 is increased by the increase in rotational speed of the rotor 140. Therefore, it is possible to obtain an advantageous effect of stably ensuring the performance in cooling the coil 130.

Moreover, in the embodiment of the present disclosure, the amount of the cooling oil CO to be sprayed to the coil 130 is adjusted depending on the rotational speed of the rotor 140. Therefore, it is not necessary to additionally provide a temperature sensor for detecting a temperature of the cooling oil CO and a controller for controlling the operation of the oil pump 166 in response to a signal detected by the temperature sensor. Therefore, it is possible to obtain an advantageous effect of simplifying the structure and operational structure and reducing costs.

Meanwhile, in the embodiment of the present disclosure illustrated and described above, the example has been described in which the oil pump 166 is operated by the rotational force of the rotor 140. However, according to another embodiment of the present disclosure, a separate motor may be provided to operate the oil pump.

According to the exemplary embodiment of the present disclosure, the motor 10 may include a heat exchange part 180 configured to allow the coolant in the water-cooled cooling part 150 to exchange heat with the cooling oil CO in the oil-cooled cooling part 160.

The heat exchange part 180 may have various structures capable of allowing the coolant and the cooling oil CO to exchange heat with each other. The present disclosure is not restricted or limited by the structure of the heat exchange part 180.

According to the exemplary embodiment of the present disclosure, the heat exchange part 180 may include a heat exchange flow path 182 defined between the stator 120 and the motor housing 110. The cooling oil CO, which is stored at the lower side of the motor housing 110, may be cooled by the heat exchange with the coolant while moving along the heat exchange flow path 182.

For example, the heat exchange flow path 182 may be defined between a lowermost end of the stator 120 based on the upward/downward direction and the motor housing 110 (a space defined between the motor housing and the stator and configured to store the cooling oil).

As described above, in the embodiment of the present disclosure, the cooling oil CO is cooled by the heat exchange with the coolant while moving along the heat exchange flow path 182, such that the cooling performance implemented by the cooling oil CO may be stably ensured. Further, because a separate cooling device for cooling the cooling oil CO is not required, it is possible to obtain an advantageous effect of simplifying the structure and operational structure and reducing costs.

According to the embodiment of the present disclosure described above, it is possible to obtain an advantageous effect of improving the cooling performance, stability, and reliability.

In particular, according to the embodiment of the present disclosure, it is possible to obtain an advantageous effect of effectively ensuring both the performance in cooling the core portion of the coil (or the stator) and the performance in cooling the end turn portion of the coil.

In addition, according to the embodiment of the present disclosure, it is possible to obtain an advantageous effect of simplifying the structure and reducing the costs.

In addition, according to the embodiment of the present disclosure, it is possible to obtain an advantageous effect of minimizing electric power consumption and improving energy efficiency.

While the embodiments have been described above, the embodiments are just illustrative and not intended to limit the present disclosure. It can be appreciated by those skilled in the art that various modifications and applications, which are not described above, may be made to the present embodiment without departing from the intrinsic features of the present embodiment. For example, the respective constituent elements specifically described in the embodiments may be modified and then carried out. Further, it should be interpreted that the differences related to the modifications and applications are included in the scope of the present disclosure defined by the appended claims.

What is claimed is:

1. A motor comprising:
a motor housing;
a stator provided in the motor housing;
a coil wound around the stator;
a rotor rotatably provided inside the stator;
a water-cooled cooling part provided in the motor housing and including a water jacket configured to define a coolant flow path through which a coolant circulates; and
an oil-cooled cooling part provided in the motor housing and configured to spray cooling oil to the coil.

2. The motor of claim 1, wherein the water jacket is provided to surround a periphery of the stator while corresponding to the stator, and the oil-cooled cooling part sprays the cooling oil to an end turn portion of the coil exposed to an end of the stator.

3. The motor of claim 1, wherein the oil-cooled cooling part comprises:
a cooling oil flow path provided in the motor housing and configured to guide the cooling oil, which is stored at one side of the motor housing, to another side of the motor housing to surround the coil;
a spray hole provided in the motor housing and configured to communicate with the cooling oil flow path to spray the cooling oil to the coil; and
an oil pump provided in the cooling oil flow path and configured to pump the cooling oil.

4. The motor of claim 3, wherein the spray hole comprises:
a first spray hole provided in the motor housing while corresponding to a first end turn portion of the coil exposed to one end of the stator; and
a second spray hole provided in the motor housing while corresponding to a second end turn portion of the coil exposed to the other end of the stator.

5. The motor of claim 3, wherein the oil pump is configured to pump the cooling oil on the basis of a rotation of the rotor.

6. The motor of claim 5, comprising:
a power transmission part configured to transmit a rotational force of the rotor to the oil pump as driving power.

7. The motor of claim 6, wherein the power transmission part comprises:
a first gear connected to a shaft of the rotor; and
a second gear connected to the oil pump and configured to engage with the first gear.

8. The motor of claim 7, wherein the first and second gears are defined to be different in number of teeth, and the second gear rotates at a lower rotational speed than the first gear.

9. The motor of claim 1, comprising:
a heat exchange part configured to allow the coolant and the cooling oil to exchange heat with each other.

10. The motor of claim 9, wherein the heat exchange part comprises a heat exchange flow path defined between the stator and the motor housing, and the cooling oil, which is stored at a lower side of the motor housing, is cooled by heat exchange with the coolant while moving along the heat exchange flow path.
